(19) United States
(12) Patent Application Publication
(10) Pub. No.: US 2024/0337134 A1
(43) Pub. Date: Oct. 10, 2024

(54) CONTROL DEVICE FOR A PUSH BAR LATCH

(71) Applicant: YI FAN LIAO, TAOYUAN CITY (TW)

(72) Inventor: YI FAN LIAO, TAOYUAN CITY (TW)

(21) Appl. No.: 18/355,113

(22) Filed: Jul. 19, 2023

(30) Foreign Application Priority Data
Apr. 6, 2023 (TW) 112203124

(51) Int. Cl. E05B 65/10; E05B 47/00

(52) U.S. Cl. CPC E05B 65/1046; E05B 47/0002

(57) ABSTRACT

A control device for a push bar latch, comprising: a base frame having a sliding slot; a control connecting rod, the outer end is combined with an unlocking return unit of the push bar latch and the inner end has a positioning pin, the positioning pin is set through the sliding slot; a locking lever, the outer end has a blocking member relative to the positioning pin; an electromagnet, used for holding the inner end section of the locking lever, so let the blocking member enter a locking state for the positioning pin; and a release element, used to release the blocking member from the locking state for the positioning pin when the electromagnet is powered off. Whereby the push bar latch has the enter control function.

### BACKGROUND OF THE INVENTION

### 1. Field of the Invention

The invention relates to a control device for a push bar latch, especially the one who has an enter control function.

### 2. Description of the Related Art

As showing in FIG. 1, the push bar latch 10 can be unlocked by pushing the push rod 11 to go out, and the setting range of the push rod 11 is very large, so that the push bar latch 10 is very convenient for unlocking and is often used in exit doors; however, there are more and more demands for access control, as long as there are no security concerns, adding a control device to the push bar latch 10 can facilitate the entry and exit of people and has enter control function.

### SUMMARY OF THE INVENTION

It is a primary objective of the present invention to provide a control device for a push bar latch, especially the one who has enter control function.

In order to achieve the above objectives, the present invention comprise: a base frame having a sliding slot; a control connecting rod, the outer end is combined with an unlocking return unit of the push bar latch and the inner end has a positioning pin, the positioning pin is set through the sliding slot; a locking lever, pivoted on the base frame, and the outer end has a blocking member relative to the positioning pin; an electromagnet, arranged on the base frame relative to the inner end section of the locking lever, and used for holding the inner end section of the locking lever, so let the blocking member enter a locking state for the positioning pin; and a release element, arranged on the base frame relative to the locking lever, and used to release the blocking member from the locking state for the positioning pin when the electromagnet is powered off.

Moreover, set a push spring at base frame relative to the outer end of the locking lever.

### BRIEF DESCRIPTION OF THE DRAWINGS

FIG. 1 is a schematic diagram illustrating structure of the push bar latch installed with the present invention;

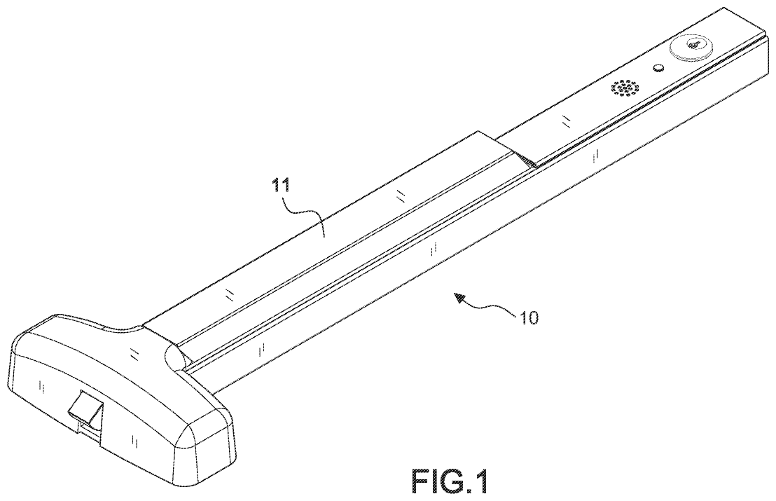

FIG. 2 is a perspective views of the present invention;

FIG. 3 is a sectional views of the present invention in close mode;

FIG. 4 is a sectional views of the present invention in open mode;

FIG. 5 is a sectional views of the present invention in unlocking mode.

### DETAILED DESCRIPTION OF THE PREFERRED EMBODIMENT

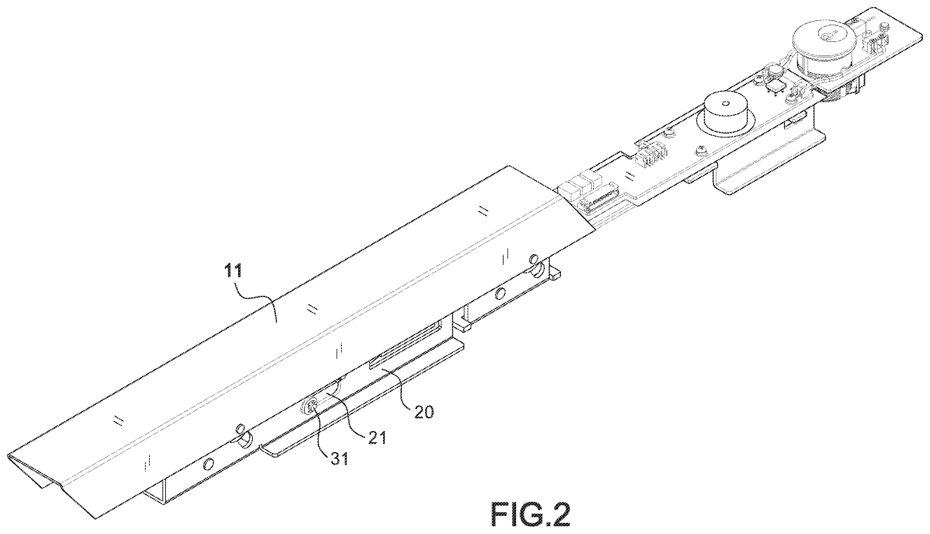

Referring to FIGS. 2-5, the present invention, including: a base frame 20 having a sliding slot 21; a control connecting rod 30, the outer end is combined with an unlocking return unit 12 (when the push rod 11 is pressed down to unlock, the unlocking return unit 12 will shift to the lower right in the figure, and the unlocking return unit 12 returns to the locked position through the torsion spring 13) of the push bar latch 10 and the inner end has a positioning pin 31, the positioning pin 31 is set through the sliding slot 21; a locking lever 40, pivoted on the base frame 20, and the outer end has a blocking member 41 relative to the positioning pin 31; an electromagnet 50, arranged on the base frame 20 relative to the inner end section of the locking lever 40, and used for holding the inner end section of the locking lever 40, so let the blocking member 41 enter a locking state for the positioning pin 31; and a push spring at base frame relative to the outer end of the locking lever, let the inner end section of the locking lever 40 and the electromagnet 50 maintain a touched state to ensure that the electromagnet 50 can generate adsorption force on the inner end section of the locking lever 40 when the electromagnet 50 is energized.

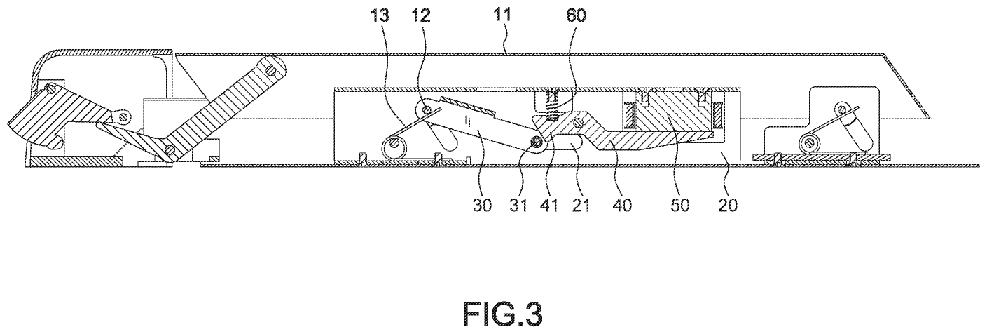

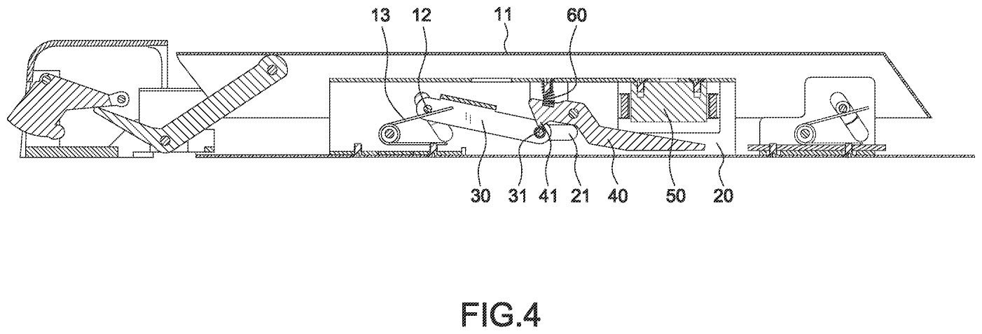

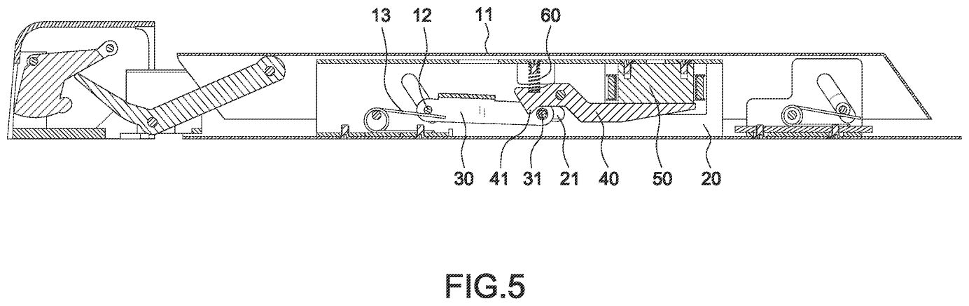

With the feature disclosed above, after the outer end of the control connecting rod 30 of the present invention is combined with the unlocking return unit 12 of the push bar latch 10, when the electromagnet 50 is energized to attract the inner end of the locking lever 40, let the blocking member 41 enter a locking state for the positioning pin 31 of the control connecting rod 30, as FIG. 3 showing, so that the unlocking return unit 12 is locked (cannot move to the lower right side of the drawing), and the push bar latch 10 is in close mode, when someone pushes the push rod 11 at this time, the lock cannot be unlocked; in addition, when the electromagnet 50 is powered off, release the blocking member 41 from the locking state of the positioning pin 31, as FIG. 4 showing, and the push bar latch 10 is in open mode that returns to the normal use state of the push bar latch 10, when someone pushes the push rod 11 at this time, the positioning pin 31 can pass through the blocking member 41 to unlock, as FIG. 5 showing; therefore, the push bar latch 10 has the enter control function.

The base frame 20 can be a base frame owned by the push bar latch, and the design of the push bar latch is various, during the unlocking process, in addition to the situation above-mentioned that the unlocking return unit 12 can shift to the lower right in the figure, other designs can also be shifted to the lower left in the figure, or even simply shifted to the left or right, and the mechanism of the present invention can be applied to all of them; wherein if the push bar latch is the kind that will make the unlocking return unit 12 shift to the right in the figure, the initial position of the positioning pin 31 will be located on the left side of the blocking member 41, and the electromagnet 50 can hold the blocking member 41 through magnetic force to prevent the positioning pin 31 from shifting to the right, so that the positioning pin 31 enters the locked state; also, if the push bar latch is the kind that will make the unlocking return unit 12 shift to the left in the figure, the initial position of the positioning pin 31 will be located on the right side of the blocking member 41, and the electromagnet 50 can hold the blocking member 41 through magnetic force to prevent the positioning pin 31 from shifting to the left, so that the positioning pin 31 enters the locked state.

What is claimed is:

1. A control device for a push bar latch, comprising:
a base frame having a sliding slot;
a control connecting rod, the outer end is combined with an unlocking return unit of the push bar latch and the inner end has a positioning pin, the positioning pin is set through the sliding slot;
a locking lever, pivoted on the base frame, and the outer end has a blocking member relative to the positioning pin;
an electromagnet, arranged on the base frame relative to the inner end section of the locking lever, and used for holding the inner end section of the locking lever, so let the blocking member enter a locking state for the positioning pin; and
a release element, arranged on the base frame relative to the locking lever, and used to release the blocking member from the locking state for the positioning pin when the electromagnet is powered off.

2. The control device for a push bar latch as claimed in claim 1, wherein set a push spring at base frame relative to the outer end of the locking lever.
